(19) United States
(12) Patent Application Publication
(10) Pub. No.: US 2025/0211580 A1
(43) Pub. Date: Jun. 26, 2025

(54) SYSTEMS AND METHODS FOR ACCESSING SECURITY ALERTS WITH PRIVACY-BASED OBFUSCATION

(71) Applicant: ATLASSIAN PTY LTD, Sydney (AU)

(72) Inventors: Anthony Knopp, New York, NY (US); Benjamin Walther, Mountain View, CA (US); Ryan Crumley, Austin, TX (US)

(21) Appl. No.: 18/395,984

(22) Filed: Dec. 26, 2023

(51) Int. Cl. H04L 9/40

(52) U.S. Cl. CPC H04L 63/0414; H04L 63/1416; H04L 63/20

(57) ABSTRACT

Systems and methods provide techniques for improving user information security using data obfuscation. In various embodiments, a method includes obtaining an alert associated with a unique user identifier (UUID) based at least in part on a real-time monitoring of user activities on an application. The method further includes rendering a graphical user interface (GUI) comprising the alert on an administrator computing device via an application programming interface (API). The method further includes receiving, via the API, a request for user data associated with the alert, and obtaining user data and at least one user-configured privacy policy based on the UUID. The method further includes generating obfuscated user alert data at least in part by applying the at least one user-configured privacy policy to the user data. The method further includes causing provision of the obfuscated user alert data to the administrator computing device via the API for rendering on the GUI.

### BACKGROUND

Various methods, apparatuses, and systems are configured to provide techniques for provisioning security alert-related information to an administrator while acquiescing to user-configured privacy policies. Applicant has identified many deficiencies and problems associated with existing methods, apparatuses, and systems for accessing security-related information while simultaneously respecting user privacy. Through applied effort, ingenuity, and innovation, these identified deficiencies and problems have been solved by developing solutions that are in accordance with the embodiments of the present disclosure, many examples of which are described in detail herein.

### BRIEF SUMMARY

In general, embodiments of the present disclosure provide methods, apparatuses, systems, computing devices, and/or the like that are configured to enable administrator computing devices to access security-related information without violating user-configured privacy policies. For example, certain embodiments of the present disclosure provide methods, apparatuses, systems, computing devices, and/or the like that are configured to generate obfuscated user alert data based on user-configured privacy policies such that, where said user data is invoked in a security alert, the obfuscated user alert data may be provisioned to an administrator computing device instead of original user data. In doing so, the present techniques enable the administrator computing device to observe and investigate security alerts, trends, and/or the like without unduly impinging upon user privacy.

In accordance with one aspect, a method is provided. In one embodiment, the method comprises: obtaining an alert associated with at least one unique user identifier (UUID) based at least in part on a real-time monitoring of user activities; rendering a graphical user interface (GUI) comprising the alert on an administrator computing device via an application programming interface (API); receiving, via the API, a request for user data associated with the alert; obtaining user data and at least one user-configured privacy policy based on the at least one UUID; generating obfuscated user alert data at least in part by applying the at least one user-configured privacy policy to the user data; and causing provision of the obfuscated user alert data to the administrator computing device via the API for rendering on the GUI.

In some embodiments, the user data comprises a plurality of filenames accessed by at least one user associated with the at least one UUID. In some embodiments, generating the obfuscated user alert data comprises generating a file count based on the plurality of filenames, wherein the obfuscated user alert data comprises the file count and excludes the plurality of filenames. In some embodiments, the user data comprises respective access timestamps for the plurality of filenames, wherein each timestamp indicates a date of access by the at least one user associated with the at least one UUID. In some embodiments, the method further comprises: generating an access frequency count for each of the plurality of filenames based on the respective access timestamps; and generating the file count based on a subset of the plurality of filenames for which the respective access frequency count satisfies a predetermined threshold.

In some embodiments, the method further comprises generating a data visualization based on the subset of the plurality of filenames and the respective access frequency counts; and causing provision of the data visualization to the administrator computing device via the API for rendering on the GUI. In some embodiments, the method further comprises generating a user count based on the at least one UUID, wherein the obfuscated user alert data comprises the user count and excludes the at least one UUID. In some embodiments, the method further comprises disabling the administrator computing device from executing one or more operations to copy the obfuscated user alert data from the GUI.

In some embodiments, the method further comprises, in response to the alert, generating a communication session between the administrator computing device and at least one additional computing device, wherein the communication session is associated with a predetermined expiration interval. In some embodiments, the method further comprises, in response to determining completion of the predetermined expiration interval: automatically terminating the communication session; and deleting communication data associated with the communication session. In some embodiments, the method further comprises causing provision of a request to generate the communication session to a second administrator device; and generating the communication session in response to receiving an approval of the request from the at least one additional computing device. In some embodiments, the request to generate the communication session comprises at least one of the alert or the obfuscated user alert data.

In some embodiments, the user data comprises a plurality of fields; and the obfuscated user alert data comprises a permitted subset of the plurality of fields based on the at least one user-configured privacy policy. In some embodiments, the plurality of fields comprises at least one of a username, legal name, user image, email address, location, timezone, organization, department, or team type. In some embodiments, the plurality of fields comprises at least one of demographic data, political data, religion data, union membership data, biometric data, or health data. In some embodiments, the method further comprises receiving, via the API, a second request from the administrator computing device for deobfuscation of at least one portion of the obfuscated user alert data; and generating a response to the second request based on at least one of i) at least one organization policy associated with the at least one UUID, or ii) at least one administrator privilege associated with the administrator computing device, wherein the response comprises a portion of the user data associated with the at least one portion of the obfuscated user alert data. In some embodiments, the request comprises administrator profile data associated with the administrator computing device; and the method further comprises updating an access registry based on the administrator profile data in response to the provision of the obfuscated user alert data to the administrator computing device.

In some embodiments, the method further comprises, in response to the alert, updating at least one privilege associated with the administrator computing device to enable the administrator computing device to request the user data respective to the at least one UUID. In some embodiments, the user data comprises an internet protocol (IP) address; and the method further comprises generating generalized location data based on the IP address, wherein the obfuscated user alert data comprises the generalized location data and excludes the IP address. In some embodiments, the generalized location data comprises at least one of: a hemisphere identifier, a country identifier, or a regional identifier.

In accordance with another aspect, a computer program product is provided. The computer program product in some embodiments includes at least one non-transitory computer-readable storage medium having computer program code stored thereon. The computer program code in execution with at least one processor is configured for performing any one of the example computer-implemented methods described herein. In some embodiments, the at least one non-transitory computer-readable storage medium having computer program code comprising executable portions configured to: obtain an alert associated with at least one unique user identifier (UUID) based at least in part on a real-time monitoring of user activities; render a graphical user interface (GUI) comprising the alert on an administrator computing device via an application programming interface (API); receive, via the API, a request for user data associated with the alert; obtain user data and at least one user-configured privacy policy based on the at least one UUID; generate obfuscated user alert data at least in part by applying the at least one user-configured privacy policy to the user data; and cause provision of the obfuscated user alert data to the administrator computing device via the API for rendering on the GUI.

In accordance with yet another aspect, an apparatus comprising at least one processor and at least one memory including computer program code is provided. The computer program code in execution with the at least one processor causes the apparatus to perform any one of the example computer-implemented methods described herein. In some other embodiments, the apparatus includes means for performing each step of any of the computer-implemented methods described herein. In one embodiment, the at least one memory and the computer program code may be configured to, with the processor, cause the apparatus to: obtain an alert associated with at least one unique user identifier (UUID) based at least in part on a real-time monitoring of user activities; render a graphical user interface (GUI) comprising the alert on an administrator computing device via an application programming interface (API); receive, via the API, a request for user data associated with the alert; obtain user data and at least one user-configured privacy policy based on the at least one UUID; generate obfuscated user alert data at least in part by applying the at least one user-configured privacy policy to the user data; and cause provision of the obfuscated user alert data to the administrator computing device via the API for rendering on the GUI.

### BRIEF DESCRIPTION OF THE SEVERAL VIEWS OF THE DRAWINGS

Having thus described some embodiments in general terms, references will now be made to the accompanying drawings, which are not drawn to scale, and wherein:

FIG. 1 is a block diagram of an example network environment in which a specially configured privacy obfuscation system may operate in accordance with one or more embodiments of the present disclosure.

FIG. 2 is a block diagram of an example apparatus that may embody the specially configured privacy obfuscation system in accordance with one or more embodiments of the present disclosure.

FIG. 3 is a block diagram of an example apparatus that may embody an administrator computing device in accordance with at least some embodiments of the present disclosure.

FIG. 4 provides a flowchart diagram of an example obfuscation process for provisioning security-related information to an administrator computing device while complying with user-configured privacy policies in accordance with at least some embodiments of the present disclosure.

FIG. 5 shows an administrator computing device including an example obfuscated user alert data interface in accordance with at least some embodiments of the present disclosure.

FIG. 6A shows an administrator computing device including an example obfuscated user alert data interface in accordance with at least some embodiments of the present disclosure.

FIG. 6B shows an administrator computing device including an example obfuscated user alert data interface in accordance with at least some embodiments of the present disclosure.

FIG. 7A shows an administrator computing device including an example obfuscated user alert data interface in accordance with at least some embodiments of the present disclosure.

FIG. 7B shows an administrator computing device including an example obfuscated user alert data interface in accordance with at least some embodiments of the present disclosure.

FIG. 8 shows an administrator computing device including an example obfuscated user alert data interface in accordance with at least some embodiments of the present disclosure.

### DETAILED DESCRIPTION OF VARIOUS EMBODIMENTS

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

### Overview

Administrators of software applications may have access to large volumes of user data. Individual users, user-affiliated organizations, and/or the like may have varying degrees of tolerance to the disclosure of such data, including for internal administrative purposes such as security monitoring and intrusion detection. Further, the control and traceability of user data disclosures may be important for complying with regulatory requirements and internal, user-configured, and organizational policies. When reviewing security alerts and trends, the disclosure of some user data may be necessary; however, such security and monitoring processes may remain accountable to privacy policies, which may vary significantly across individual users and organizations. In existing approaches to investigating and evaluating alerts, the ability of an administrator to access and view user data is typically based on a privilege level of the administrator. For example, in such approaches, an administrator with generalized privileges to query user data may be able to freely lookup any user's name, address, contact information, image, and/or the like, regardless of whether the user acquiesces to such data being freely discoverable to the administrator. In contrast, the privacy obfuscation techniques provided herein enable alert investigation and evaluation processes to be performed in compliance with individual users' privacy settings, including in instances where such settings vary from user to user. In doing so, the techniques may improve data security and user satisfaction by controlling the depth of user information that may be freely accessed by administrators.

To address the above-described challenges related to selectively disclosing user data for security purposes, various embodiments of the present disclosure described techniques for selectively obfuscating user data based at least in part on user-configured privacy policies. For example, the technique may include generating aggregated or abstracted representations of user data that enable administrators to observe trends in user activity, but do not explicitly disclose user-identifying information or individual user information.

By utilizing the noted techniques for selectively obfuscating data, various embodiments of the present disclosure preserve compliance with user-configured privacy policies in security instances where administrators may desire to understand and summarize recent user activities. In doing so, the noted embodiments of the present disclosure can better secure user data against unnecessary exposure and wanton investigation. By integrating data abstraction, aggregation, anonymization, and filtering techniques into processes for performing alert-based queries of user data on behalf of administrator devices, the described embodiments of the present disclosure enhance data security.

### Definitions

As used herein, the terms “data,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The terms “computer-readable storage medium” refers to a non-transitory, physical or tangible storage medium (e.g., volatile or non-volatile memory), which may be differentiated from a “computer-readable transmission medium,” which refers to an electromagnetic signal.

As used herein, the term “administrator computing device” refers to computer hardware and/or software that is configured to review user behavior and security trends for one or more applications. Administrator computing devices may include, without limitation, smart phones, tablet computers, laptop computers, wearables, personal computers, enterprise computers, and the like.

A used herein, the term “alert” refers to any data object for indicating anomalous or irregular activity on one or more applications. An alert may include data associated with the anomalous or irregular activity, including descriptions of the activity (e.g., anomalous access pattern, unrecognized location, unauthorized access, and/or the like) and identifiers for one or more users associated with the activity. An alert may be provisioned to an administrator computing device. For example, the alert may embody an instant message, push notification, email, text message, and/or the like, that is provisioned to an administrator computing device via one or more networks.

As used herein, “application” refers to any program code executable by logic circuitry of one or more computing devices, such as a server processor. In some embodiments, an application is a computer program accessible to an entity via a computing device and which performs a specific function directly or indirectly for the entity, the computing device, another application, and/or the like. In some embodiments, an application includes a local software program installed and executed on a computing device accessible to an entity. In some embodiments, an application includes a remotely executed software program accessible to the entity via the entity's computing device and a suitable network connection to the corresponding remote computing environment.

Non-limiting examples of applications include local computer programs, remote computer programs, services, microservices, software modules, communication interfaces, and/or the like. In one example, an application may be a ticketing and project management service, such as Jira™. In another example, an application may be a cloud-based computing environment that enables collaborative workflows, such as Confluence™. In another example, an application may be a remote computing environment that provides program repository services, such as Bitbucket™. In still another example, an application may be an electronic mail (e-mail) and scheduling management platform. Other examples of applications include project visualization tools, incident management tools, user administration and authentication programs, collaborative work platforms, risk management and monitoring services, software testing tools, and/or the like. In some embodiments, application may refer to specific functions, features, services, and/or the like that are accessible using executable program code, or portion thereof. For example, application may refer to a specific functionality or action that may be performed using an application.

As used herein, “user activity” refers to any action initiated by a user, or a computing device of a user, respective to an application or within the application. For example, user activity may include a user initiating actions within the application to view one or more webpages or access or view particular resources. As another example, user activity may include a user signing into a user account, modifying one or more settings of a user account, registering a new user account, and/or the like. In another example, a user activity may include a user accessing functions, features, services, and/or the like provisioned by the application.

As used herein, “user data” refers to any data object associated with defining aspects of a user or user activity of the user. For example, the user data may include usernames, legal names, user images, email addresses and/or other contact information, user locations, user timezone, organization affiliations, department affiliations, team types, and/or the like. As another example, the user data may include demographic data, political data, religion data, union membership data, biometric data, health data, and/or the like. In some embodiments, the user data includes search terms, query parameters, and/or the like. For example, the user data may include specific keywords provided by a user as an input to a search engine, file explorer, database interface, and/or the like. In some embodiments, the user data includes temporal features associated with user activities. For example, the user data includes timestamps corresponding to occurrences of particular user activities. In another example, the user data includes lists of page names, particular services, particular actions, and/or the like, accessed or initiated by a user. In some embodiments, the user data indicates a frequency of one or more user activities. For example, the user data may indicate a frequency with which a user accessed one or more pages within a given time interval (e.g., 1 day, 1 week, 1 month, and/or the like).

As used herein, “alert-related user data” refers to user data that is associated with one or more user activities that triggered the generation of an alert. For example, alert-related user data may include or embody a particular filename, webpage, keyword, input, user-initiated action, and/or the like that caused generation of an alert upon its detection in a real-time monitoring of user activities on one or more applications.

As used herein, “alert-related query” refers to a query of user data that is performed based on one or more aspects of an alert. In some embodiments, the aspects of the alert include any unique user identifiers (UUIDs) associated with the alert, one or more time intervals associated with the alert, one or more applications associated with the alert, and/or the like. In some embodiments, an alert-related query returns as output alert-related user data and non-alert-related user data. The non-alert-related user data may be associated with a same or similar time interval, application, and/or the like as the alert-related user data.

As used herein, “obfuscated user alert data” refers to any user data, representations of user data, and/or the like that may be obtained from an alert-based query of user data and where such data is processed using one or more obfuscation techniques. In some embodiments, obfuscated user alert data is generated based on alert-related user data, where the alert-related user data is associated with triggering the generation of an alert. For example, obfuscated user alert data may include, or be generated based on, a particular filename accessed that was accessed by a user, where such access triggered the generation of an alert. Additionally, or alternatively, in some embodiments, obfuscated user alert data is generated based on non-alert-related user data that is obtained via an alert-related query (e.g., where the non-alert-related user data was not a direct trigger for generation of the alert). For example, an alert may be triggered based on a user accessing a particular file, the user being associated with a particular unique user identifier (UUID). An alert-related query may be performed based on the UUID. The alert-related query may return, as output, the filename of the particular file that triggered the alert and also respective filenames for a plurality of additional files accessed by the user within the same time interval (e.g., 1 hour, 1 day, 1 week, or any suitable interval), but did not result in triggering of the alert. Obfuscated user alert data may be generated based on both the filename of the particular file and respective filenames of the plurality of additional files. As another example, an alert may be triggered in response to a user executing a search, query, and/or the like that includes a particular keyword. Obfuscated user alert data may be generated based on the particular keyword and the alert. The obfuscated user alert data may include a category associated with the particular keyword and exclude the keyword itself such that an administrator computing device may be presented with only the category of keyword that triggered the alert.

In various embodiments, obfuscation techniques include data aggregation, data abstraction or generalization, filtering, redaction, and/or the like. For example, obfuscated user alert data may include a count of users that is generated based on a listing of usernames, where the listing of usernames is returned as output of an alert-related query. As another example, obfuscated user alert data may include a count of files that is generated based on a listing of specific files accessed by a user. As still another example, obfuscated user alert data may include an access frequency count that is generated based on respective timestamps for a plurality of file access actions initiated by a user.

Methods, apparatuses, and computer program products of the present disclosure may be embodied by any of a variety of devices. For example, the method, apparatus, and computer program product of an example embodiment may be embodied by a networked device (e.g., an enterprise platform), such as a server or other network entity, configured to communicate with one or more devices, such as one or more query-initiating computing devices. Additionally, or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, or any combination of the aforementioned devices.

### Example System Architecture

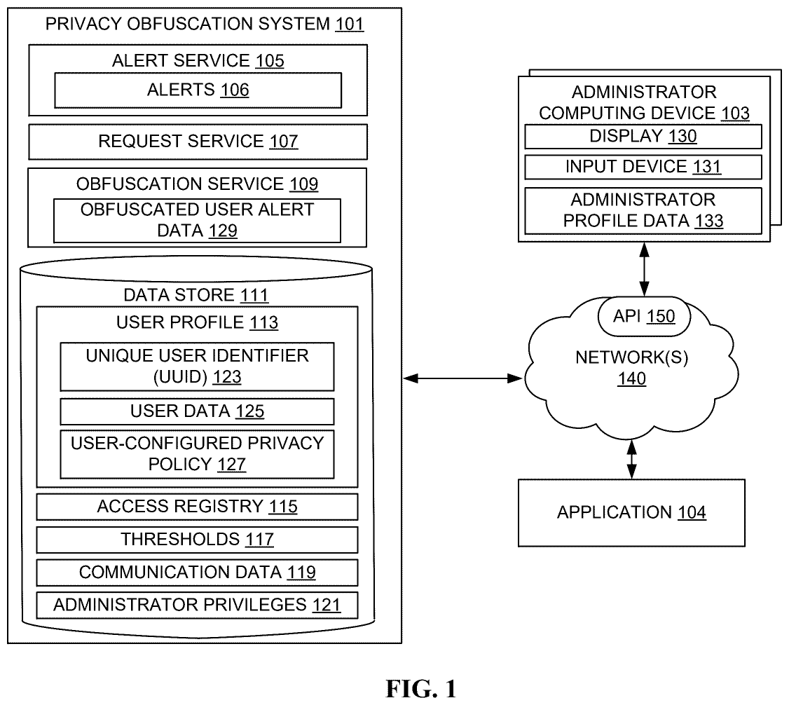

FIG. 1 illustrates an example network environment 100 in which a specially privacy obfuscation system may operate in accordance with one or more embodiments of the present disclosure. In some embodiments, the network environment 100 includes a privacy obfuscation system 101 configured to communicate with other elements of the network environment 100 via one or more networks 140. In some embodiments, other elements of the network environment 100 include one or more administrator computing devices 103 and one or more applications 106. In some embodiments, the privacy obfuscation system 101 is configured to obtain alerts based on a real-time monitoring of user activities within one or more applications 106 and provision the alerts to administrator computing devices 103. In some embodiments, the privacy obfuscation system 101 is further configured to receive requests for user data associated with alerts and respond to the requests by performing alert-based queries of user data and providing obfuscated versions of the user data returned by the query. In some embodiments, the privacy obfuscation system 101 automatically generates obfuscated user alert data respective to an alert and provisions the obfuscated user alert data to the administrator computing device in combination with the alert. In various embodiments, by performing one or more obfuscation operations, the privacy obfuscation system 101 filters the contents of request responses such that the responses comply with user-configured privacy policies and abstract from original user data. In doing so, the privacy obfuscation system 101 improves data security by replacing individualized user data with aggregated, anonymized, and/or abstracted representations of the user data.

The administrator computing device 103 includes one or more computing device(s) accessible to an administrator and configured to present information related to real-time monitoring of user activities on one or more applications 104. In some embodiments, the administrator computing device 103 includes a personal computer, laptop, smartphone, tablet, Internet-of-Things enabled device, smart home device, virtual assistant, alarm system, workstation, work portal, and/or the like. The administrator computing device 103 may include one or more displays 130, one or more visual indicator(s), one or more audio indicator(s) and/or the like that enables output of information to the particular entity. For example, the privacy obfuscation system 101 may cause provision of a graphical user interface (GUI) to the administrator computing device 103, and the administrator computing device 103 may render the GUI on the display 130. In some embodiments, the administrator computing device 103 includes one or more input devices 131 for receiving user inputs, such as commands to initiate an alert-based query of user data or request deobfuscation of obfuscated user alert data. In some embodiments, the input device 131 includes one or more buttons, cursor devices, touch screens, including three-dimensional- or pressure-based touch screens, camera, fingerprint scanners, accelerometer, retinal scanner, gyroscope, magnetometer, and/or other input devices.

In some embodiments, the administrator computing device 103 stores administrator profile data 133 that uniquely identifies the administrator computing device 103 and/or user thereof and includes information for controlling access of the administrator computing device 103 to user data 125. For example, the administrator profile data 133 may include one or more device identifiers, such as serial number, international mobile equipment identity (IMEI) number, internet protocol (IP) address, media access control (MAC) address, and/or the like. In some embodiments, the administrator profile data 133 includes information that uniquely identifies a user of the administrator computing device 103 (e.g., an administrator of one or applications, application providers, and/or the like). For example, the administrator profile data 133 may include administrator credentials, tokens, keys, and/or the like.

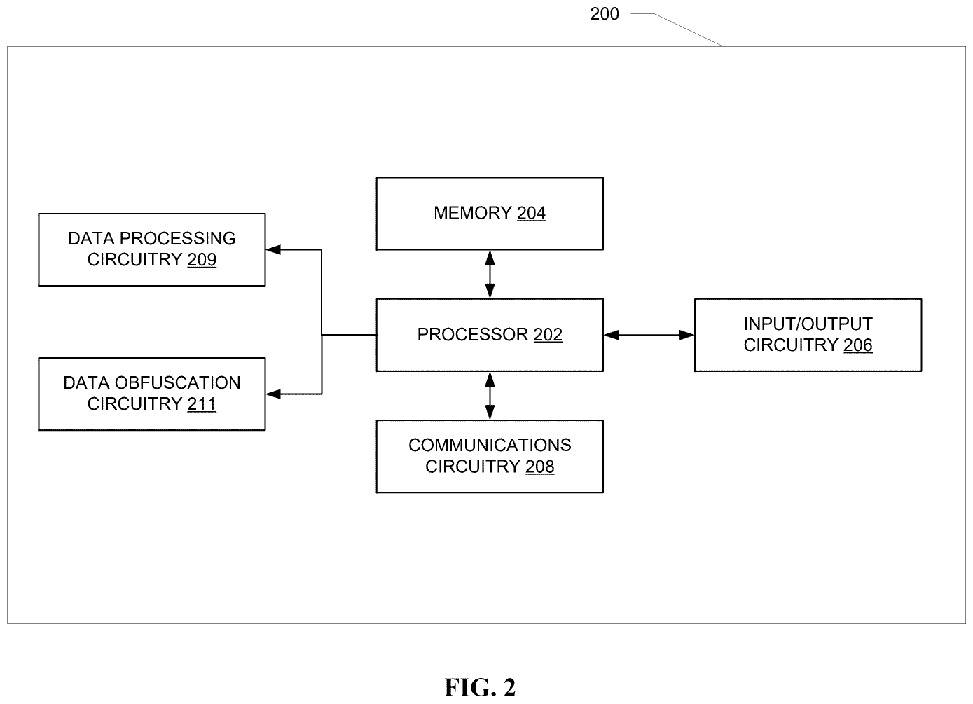

In some embodiments, the privacy obfuscation system 101 is embodied as, or includes one or more, of a privacy obfuscation apparatus 200 (e.g., as further illustrated in FIG. 2 and described herein). Various applications and/or other functionality may be executed in the privacy obfuscation system 101 and/or privacy obfuscation apparatus 200 according to various embodiments. In some embodiments, the privacy obfuscation system 101 includes, but is not limited to, an alert service 105, a request service 107, an obfuscation service 109, and a data store 111. The elements of the privacy obfuscation system 101 can be provided via a plurality of computing devices that may be arranged, for example, in one or more server banks or computer banks or other arrangements. Such computing devices can be located in a single installation or may be distributed among many different geographical locations. For example, the privacy obfuscation system 101 can include a plurality of computing devices that together may include a hosted computing resource, a grid computing resource, and/or any other distributed computing arrangement. In some cases, the privacy obfuscation system 101 can correspond to an elastic computing resource where the allotted capacity of processing, network, storage, or other computing-related resources may vary over time.

In some embodiments, the alert service 105 is configured to monitor, in real-time, user activity occurring on one or more applications 104. For example, the alert service 105 receives, from one or more applications 104, records of user inputs to the application 104, outputs provided by the application 104 to a user, actions performed by the application 104 on behalf of a user, and/or the like. In some embodiments, the alert service 105 is further configured to generate alerts 106 based on the real-time monitoring of user activities. As shown in FIG. 1, the alert service 105 may be internal to the privacy obfuscation system 101. Alternatively, in some embodiments, the alert service 105 is embodied by a computing environment that is external to the privacy obfuscation system 101 and configured to provision alerts 106 to the privacy obfuscation system 101 via one or more networks 140. In some embodiments, the alert service 105 analyzes user activity to determine whether the user activity is associated with anomalous behaviors, patterns, and/or the like. In some embodiments, the alert service 105 compares user activity to one or more thresholds 117 to determine whether the user activity is associated with anomalous behaviors, patterns, and/or the like. For example, the alert service 105 may determine whether a number of files, pages, and/or the like accessed by a user exceeds a predetermined threshold. As another example, the alert service 105 may determine whether a current count of active users meets one or more predetermined thresholds 117 associated with suspicious user activity. In still another example, the alert service 105 may determine whether a frequency of file access for one or more users and one or more files exceeds a predetermined threshold 117.

In some embodiments, the alert service 105 generates an alert 106 including a respective unique user identifier (UUID) 123 for one or more user account profiles 113 associated with the user activity based upon which the alert 106 was generated. In some embodiments, the alert 106 indicates one or more types of user activity, such as file access, page access, sign-in, settings change, credential change, and/or the like. In some embodiments, the alert 106 indicates one or more thresholds 117 that were determined to be met or violated, or are otherwise associated with generation of the alert 106.

In some embodiments, the alert service 105 stores the alert 106 in the data store 111 in association with one or more UUIDs 123. In some embodiments, the alert 106 includes user data 125. For example, the alert 106 may include a username, file name, device identifier, keyword string, and/or the like that is associated with the user profile 113. In various embodiments, prior to provisioning the alert 106 to an administrator computing device 103, the privacy obfuscation system 101 replaces the user data 125 with a UUID 123 of the user profile 113. Alternatively, in some embodiments, the alert 106 excludes UUIDs 123, user data 125, and/or the like. In some embodiments, the alert 106 is stored in association with one or more UUIDs 123 such that the administrator computing device 103 may initiate an alert-based query of user data 125 without having been provided the alert-related UUIDs 123 (e.g., the administrator computing device 103 initiating the query by providing a request comprising the alert 106, which then may be utilized by the privacy obfuscation system 101 to identify the associated UUIDs 123).

In some embodiments, the alert service 105 causes provision of alerts 106 to administrator computing devices 103. Alternatively, or additionally, in some embodiments, the alert service 105 causes rendering of graphical user interfaces (GUIs) on a display 130 of the administrator computing device 103, where the GUIs include one or more alerts. In some embodiments, the alert service 105 provisions alerts 106, GUIs, and/or the like to the administrator computing device 103 via one or more networks 140 and using one or more application programming interfaces (APIs) 150. In some embodiments, in response to generating an alert 106 respective to one or more UUIDs 123, the alert service 105 (or another element of the privacy obfuscation system 101) updates one or more administrator privileges 121 to enable an administrator computing device 103 to request user data 125 respective to the one or more UUIDs 123. In such instances where the administrator computing device 103 requests the user data 125, the privacy obfuscation system 101 may generate and provision obfuscated user alert data 129 to the administrator computing device 103 instead of provisioning the original user data 125.

In some embodiments, the request service 107 is configured to receive and process requests from administrator computing devices 103. For example, the request service 107 may receive from an administrator computing device 103 a request for user data 125 associated with an alert 106. In some embodiments, the request service 107 receives the request via one or more networks 140 and using one or more APIs 150. For example, the request service 107 (and potentially other elements of the privacy obfuscation system 101) may embody a callable function that is accessible to administrator computing devices 103 using one or more APIs 150. In some embodiments the request includes one or more UUIDs 123 that were provisioned to the administrator computing device 103 via the alert 106. Alternatively, in some embodiments, the request includes the alert 106 and excludes UUIDs 123 associated with the alert 106, such as in instances where UUIDs 123 are not provisioned to the administrator computing device 103.

In some embodiments, the request service 107 is configured to generate (or cause the generation of) communication sessions between an administrator computing device 103 and one or more additional computing devices. For example, in some instances, a particular administrator may wish to discuss an alert with additional administrators, security personnel, and/or the like. In such instances, the request service 107 may generate a communication session between the administrator computing device 103 associated with the particular administrator and one or more computing devices associated with the additional administrators, security personnel, and/or the like. In some embodiments, the request service 107 is configured to provision requests to generate or participate in communication sessions to administrator computing devices 103 and computing devices associated with security personnel or other entities associated with monitoring and/or responding to user activities.

For example, in response to the alert, the request service 107 may generate a communication session between a first administrator computing device 103 and a second administrator computing device 103. Prior to generating the communication session, the request service 107 may provision, to the second administrator computing device 103, a request to generate the communication session, where the request may include the alert, obfuscated user alert data 129, and/or the like. In response to receiving approval of the request from the second administrator computing device 103, the request service 107 may generate the communication session. In some embodiments, the request service 107 (or obfuscation service 109) may automatically terminate the communication session and delete communication data 119 associated therewith in response to determining completion of a predetermined expiration interval.

In some embodiments, the obfuscation service 109 is configured to generate obfuscated user alert data 129 based on alert-based queries of user data 125. In some embodiments, the obfuscation service is configured to generate obfuscated user alert data 129 by performing data filtration, data abstraction, and/or data aggregation operations on user data 125 returned by alert-related queries such that the obfuscated user alert data 129 complies with user-configured privacy policies 127 and reduces a likelihood of a user being uniquely identified based on the obfuscated user alert data 129. In some embodiments the obfuscation service 109 obtains user-configured privacy policies 127 from the data store 111 based on a UUID 123. For example, the administrator computing device 103 may request to query user data 125 based on an alert 106. The obfuscation service 109 may identify a UUID 123 associated with the request and/or alert 106. Based on the UUID 123 and/or alert 106, the obfuscation service 109 query user data 125 to return alert-related user data and non-alert-related user data associated with the alert. Further, based on the UUID 123, the obfuscation service 109 may obtain one or more user-configured privacy policies 127 associated with the UUID 123. The obfuscation service 109 may apply the user-configured privacy policy 127 to the query-returned user data 125 to generate obfuscated user alert data 129, which may be provisioned to the administrator computing device 103.

In some embodiments, the obfuscated user alert data 129 may embody any user data, or data derived therefrom, that is the output of one or more obfuscation techniques performed by the obfuscation service 109. As one example, the user data 125 may include a plurality of filenames accessed by a user associated with a UUID 123. Instead of provisioning the plurality of filenames to an administrator computing device 103, the obfuscation service 109 may generate obfuscated user alert data 129 including a file count based on the plurality of filenames. The file count may be provisioned to the administrator computing device 103 to indicate a quantity of files that were accessed by the user associated with the UUID 123 without disclosing the specific filenames.

As another example, the user data 125 may include respective access timestamps for the plurality of filenames, where each access timestamp indicates a time interval at which the user accessed the corresponding file. The obfuscation service 109 may generate an access frequency count for each of the plurality of filenames based on the corresponding access timestamps. The obfuscation service 109 may generate a file count based on a subset of the plurality of filenames for which the access count meets a threshold 117 (e.g., the access frequency-based file count being provisioned to an administrator computing device 103 as obfuscated user alert data). Alternatively, or additionally, the privacy obfuscation system may provision the subset of the plurality of filenames to the administrator computing device 103, thereby enabling the administrator computing device 103 to observe files most frequently accessed by the user without revealing each and every file accessed by the user.

As another example, the user data 125 may include location data of the user associated with the UUID 123, such as a physical address or internet protocol (IP) address. In some embodiments, the obfuscation service 109 generates generalized location data based on the location data such that the general location of a user may be indicated to an administrator computing device 103 without precisely identifying the user's location or related information (e.g., IP address, network provider, and/or the like). For example, based on an IP address, the obfuscation service 109 may generate generalized location data including a hemisphere identifier (e.g., northern, southern, eastern, or western), a country identifier, or a regional identifier. In some embodiments, the user data 125 includes a plurality of fields, such as username, legal name, email address, user image, and/or the like. In some embodiments, based on one or more user-configured privacy policies 127, the obfuscation service 109 generate obfuscated user alert data 129 that includes a first subset of the plurality fields and excludes a second subset of the plurality of fields (e.g., said fields being kept private from administrator computing devices 103 per user privacy policy).

In another example, the user data 125 may include one or more keywords, query parameters, and/or the like that, upon detection, triggered the generation of the alert 106. In some embodiments, the obfuscation service 109 associates the keyword with one or more categories (e.g., access token, credential, wallet address, key string, and/or the like). The obfuscation service 109 may generate obfuscated user alert data 129 that includes the category and excludes the keyword.

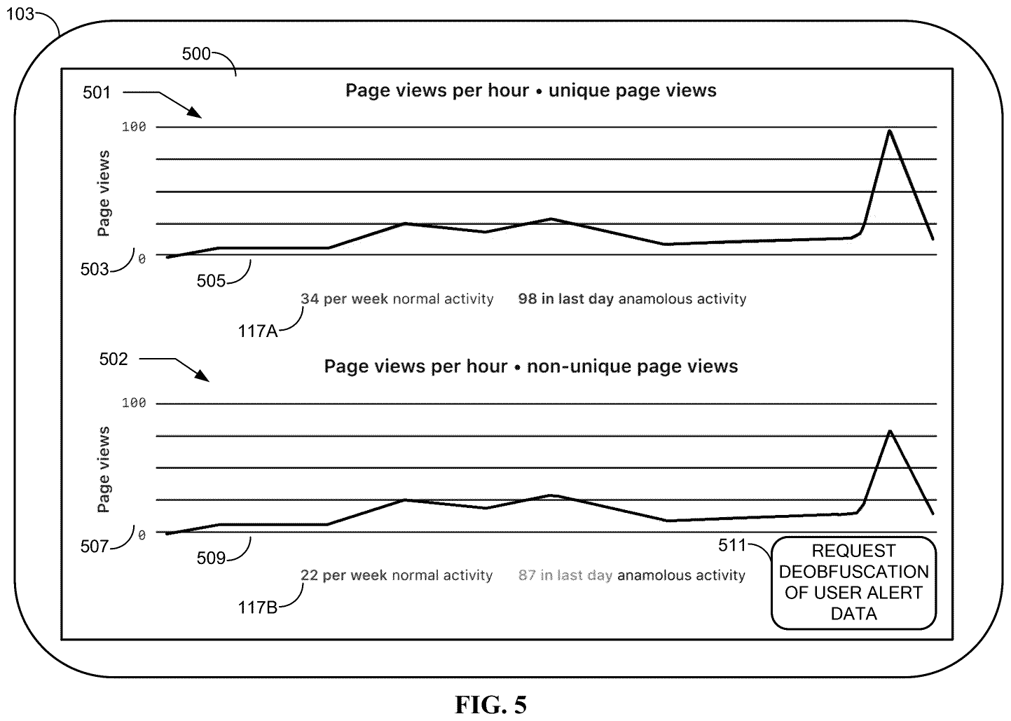

In some embodiments, the obfuscation service 109 generates data visualizations based on user data 125, obfuscated user alert data 129, and/or data derived from user data or obfuscated user alert data. For example, as shown in FIG. 5, the obfuscation service 109 may generate data visualizations for communication quantity and frequency of page access events in an application 104 and respective to one or more users. In some embodiments, the request service 107 and/or obfuscation service 109 receives from an administrator computing device 103, a request for deobfuscation of one or more portions of obfuscated user alert data 129. In some embodiments, the obfuscation service 109 may deny or perform the requested deobfuscation based on organization policies associated with the corresponding UUID 123, administrator privileges of the requesting computing device, and/or the like. If permitted, the original user data 125 obtained via the deobfuscation may be subsequently provisioned to the requesting computing device.

In some embodiments, the privacy obfuscation system 101 includes one or more data stores 111. The various data in the data store 111 may be accessible to elements of the privacy obfuscation system 101, including the alert service 105, request service 107, and obfuscation service 109, or an apparatus 200 embodying the one or more system elements. The data store 111 may be representative of a plurality of data stores 111 as can be appreciated. The data stored in the data store 111, for example, is associated with the operation of the various applications, apparatuses, and/or functional entities described herein. The data stored in the data store 111 may include, for example, user profiles 113, one or more access registries 115, one or more thresholds 117, communication data 119, and administrator privileges 121. The data store 111 may include one or more storage units, such as multiple distributed storage units that are connected through a computer network. Each storage unit in the data store 111 may store at least one of one or more data assets and/or one or more data about the computed properties of one or more data assets. Moreover, each storage unit in the data store 111 may include one or more non-volatile storage or memory media including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

In some embodiments, the user profile 113 includes a unique user identifier (UUID) 123, user data 125, and one or more user-configured privacy policies 127. In some embodiments, the UUID 123 embodies any numeric or alphanumeric identifier by which a user profile 113 may be uniquely indexed and identified. In some embodiments, the user data 125 includes any data object associated with defining aspects of a user or user activity of the user. For example, the user data 125 may include lists of files, pages, and other services or media accessed by a user. In some embodiments, the user data 125 includes temporal data indicative of when user activity occurred. For example, the user data 125 may include timestamps corresponding to a time interval at which a user accessed a file, webpage, service, and/or the like. In some embodiments, the user-configured privacy policies 127 define types of user data 125 that are permitted or unpermitted for disclosure to an administrator computing device 103. For example, a user-configured privacy policy 127 may indicate whether an administrator computing device 103 may be provisioned a user's nickname, legal name, photo, email address, location, timezone, organization affiliation, departmental affiliation, team affiliation, search terms, search parameters, and/or the like.

In some embodiments, the user profile 113 is associated with additional policies, criteria, and/or the like for controlling obfuscation of user data 125. For example, the user profile 113 may be associated with policies that limit or forbid disclosure of filenames, webpages, application functions, and/or the like that are accessed by the associated user. As another example, the user profile 113 may include policies for abstracting, aggregating, and/or anonymizing data. For example, the user profile 113 may include a policy for configuring disclosure of location data, such as a policy that only generalized location data may be disclosed. Additionally, or alternatively, in some embodiments, policies for controlling data obfuscation and user data disclosure may be embodied as one or more thresholds 117. In some embodiments, the user profile 113 further includes (or is associated with) one or more organizational policies, which may further govern the format by which user data 125 may be provisioned to administrator computing devices 103, including obfuscation and deobfuscation policies. For example, an organization policy may indicate whether requests for partial deobfuscation of particular user data 125 may be approved or denied.

In some embodiments, the access registry 115 is a time series record of requests for user data 125, where such requests may be received from administrator computing devices. In some embodiments, an entry to the access registry 115 includes or indicates a timestamp of the request, one or more UUIDs 123 associated with the request, an alert 106 associated with the request, administrator profile data 133 associated with the administrator computing device 103 from which the request was received, and/or the like. In some embodiments, the request includes administrator profile data 133. In response to receiving the request, the request service 107 may update the access registry 115 to include a new entry including the administrator profile data 133 and additional data from the request, such as a UUID 123, receipt timestamp, and/or the like.

In some embodiments, the thresholds 117 include conditions, criteria, and/or the like for controlling processes of the privacy obfuscation system 101 including generation of alerts 106, generation of obfuscated user alert data 129, and management of communication sessions and communication data 119. For example, a threshold 117 may be a predetermined frequency of initiating a particular application action, such as accessing a particular page or resource, updating credentials, downloading a file, and/or the like. As another example, a threshold 117 may be a predetermined quantity of unique files, unique pages, and/or the like that are accessed by a user. In still another example, a threshold 117 may embody a predetermined expiration interval for terminating a communication session and deleting associated communication data 119. In another example, a threshold 117 may embody a category and set of keywords, data values, query parameters, and/or the like that may be associated with the category.

In some embodiments, the communication data 119 includes any data associated with a communication session. In some embodiments, communication data 119 includes data that identifies participants of a communication session. For example, the communication data 119 may include administrator profile data 133 for administrator computing devices 103 that participated in a communication session. As another example, the communication data 119 may include an alert 106, one or more UUIDs 123, obfuscated user alert data 129, and/or the like that were discussed during the communication session. In still another example, the communication data 119 may include chat logs, files, and other inputs to the communication session. In some embodiments, the communication data 119 includes temporal data, such as a timestamp for generation of the communication session or a timestamp of the most recent input to the communication session. As described herein, the privacy obfuscation system 101 may automatically terminate communication sessions and delete associated communication data 119, such as in response to determining completion of a predetermined expiration interval or in response to detecting disclosure of original user data 125.

In some embodiments, the administrator privileges 121 define permissible or unpermitted actions for an administrator computing device 103. For example, an administrator privilege 121 may define whether an administrator computing device 103 is permitted to request user data respective to one or more UUIDs 123. Another example administrator privilege 121 may define whether such requests may be approved or denied. In another example, an administrator privilege 121 may define whether an administrator computing device 103 is permitted to request and/or initiate deobfuscation of obfuscated user alert data 129, which may be further defined on a data type, data recency, and/or UUID basis.

In some embodiments, the network environment 100 includes a first data store 111 internal to the privacy obfuscation system 101 and one or more additional data stores 111 that are external to the privacy obfuscation system 101 and accessible by the privacy obfuscation system 101 via one or more networks 140. The first data store 111 may include, for example, the user profiles 113 and thresholds 117, and the second data store 111 may include an access registry 115, communication data 119, and administrator privileges 121.

The network 140 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, the network 140 may include a cellular telephone, an 802.11, 802.16, 802.20, and/or WiMax network. Further, the network 140 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. For instance, the networking protocol may be customized to suit the needs of a group-based communication system. In some embodiments, the protocol is a custom protocol of JavaScript Object Notation (JSON) objects sent via a Websocket channel. In some embodiments, the protocol is JSON over RPC, JSON over REST/HTTP, and the like. In various embodiments, the API 150 embodies one or more interfaces and associated functions that enable communication between the privacy obfuscation system 101 and administrator computing devices 103. In some embodiments, the privacy obfuscation system 101 performs obfuscation operations (e.g., filtering, aggregation, anonymization, abstraction, and/or the like) on user data 125 prior to its provision to an administrator computing device 103 using the API 150.

### Exemplary Apparatus

The privacy obfuscation system 101 may be embodied by one or more computing systems, such as apparatus 200 shown in FIG. 2. The apparatus 200 may include processor 202, memory 204, input/output circuitry 206, communications circuitry 208, data processing circuitry 209, and data obfuscation circuitry 211. The apparatus 200 may be configured to execute the operations described herein. Although these components 202-211 are described with respect to functional limitations, it should be understood that the particular implementations necessarily include the use of particular hardware. It should also be understood that certain of these components 202-211 may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with example embodiments of the present disclosure. For example, the memory 204 may store contents of the data store 111 shown in FIG. 1 and described herein.

The processor 202 may be embodied in a number of different ways and may, for example, include one or more processing devices configured to perform independently. In some preferred and non-limiting embodiments, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 202 may be configured to execute instructions stored in the memory 204 or otherwise accessible to the processor 202. In some preferred and non-limiting embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment of the present disclosure while configured accordingly. Alternatively, as another example, when the processor 202 is embodied as an executor of software instructions, the instructions may specifically configure the processor 202 to perform the algorithms and/or operations described herein when the instructions are executed.

In some embodiments, the apparatus 200 may include input/output circuitry 206 that may, in turn, be in communication with processor 202 to provide output to the user and, in some embodiments, to receive an indication of a user input. The input/output circuitry 206 may include a user interface and may include a display, and may include a web user interface, a mobile application, a query-initiating computing device, a kiosk, or the like. In some embodiments, the input/output circuitry 206 may also include a keyboard, a mouse, a joystick, a touch screen, touch areas, soft keys, a microphone, a speaker, or other input/output mechanisms. The processor and/or user interface circuitry including the processor may be configured to control one or more functions of one or more user interface elements through computer program instructions (e.g., software and/or firmware) stored on a memory accessible to the processor (e.g., memory 204, and/or the like).

The communications circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 208 may include, for example, a network interface for enabling communications with a wired or wireless communication network. For example, the communications circuitry 208 may include one or more network interface cards, antennae, buses, switches, routers, modems, and supporting hardware and/or software, or any other device suitable for enabling communications via a network. Additionally, or alternatively, the communications circuitry 208 may include the circuitry for interacting with the antenna/antennae to cause transmission of signals via the antenna/antennae or to handle receipt of signals received via the antenna/antennae. In some embodiments, the communications circuitry 208 performs functionality of the request service. For example, the communications circuitry 208 includes one or more application programming interfaces (APIs) configured to enable the apparatus 200 to obtain user data, provision graphical user interfaces to administrator computing devices 103, receive requests from administrator computing devices 103, and provision obfuscated user alert data to the administrator computing devices 103. In some embodiments the communications circuitry 208 may include circuitry for generating and/or managing communication sessions between administrator computing devices. For example, the communication circuitry 208 may control the generation and termination of communication sessions and deletion of associated communication data.

The data processing circuitry 209 may be any means such as a device or circuitry embodied in either hardware or a combination of hardware and software that is configured to perform real-time monitoring of user activities on one or more applications 104 and generate alerts based thereon. The data processing circuitry 209 may embody functionality of the alert service 105 shown in FIG. 1 and described herein. For example, the data processing circuitry 209 may generate an alert based on determining that activity of one or more users meets one or more thresholds or conditions associated with anomalous behavior, security risks, and/or the like. As another example, responsive to generating an alert, the data processing circuitry 209 may update privileges of an administrator computing device to enable the administrator computing device to request data associated with the alert. Alternatively, the circuitry that embodies the alert service 105 may be located in another apparatus, computing environment, and/or the like, that is external to the apparatus embodying the privacy obfuscation system.

Additionally, or alternatively, the data processing circuitry 209 may be any means such as a device or circuitry embodied in either hardware or a combination of hardware and software that is configured to process requests from administrator computing devices, such as requests for user data, requests for deobfuscation of obfuscated user alert data, and/or the like. The data processing circuitry 209 may embody functionality of the request service 107 shown in FIG. 1 and described herein. For example, the data processing circuitry 209 may obtain, from a request, administrator profile data or alert-related information (e.g., UUIDs and/or the like). As another example, in response to receiving a request, the data processing circuitry may update an access registry based on administrator profile information included therein.

The data obfuscation circuitry 211 may be any means such as a device or circuitry embodied in either hardware or a combination of hardware and software that is configured to perform data obfuscation and data abstraction techniques on user data. The data obfuscation circuitry 211 may embody functionality of the obfuscation service 109 shown in FIG. 1 and described herein. The data obfuscation circuitry 211 may obtain and apply user-configured privacy policies to original user data to generate obfuscated user alert data. For example, the data obfuscation circuitry 211 may filter one or more fields of information out of the user data prior to the user data being provisioned to an administrator computing device. As another example, the data obfuscation circuitry 211 may generate abstractions of user data, such as generalized location data. The data obfuscation circuitry 211 may generate aggregated information that abstracts from original user data. For example, the data obfuscation circuitry may generate file counts, file access frequency counts, user counts, and/or the like. The data obfuscation circuitry 211 may perform deobfuscation of obfuscated user alert data, including determining whether or not such operations are permissible based on organization policies for UUIDs, administrator privileges, and/or the like.

It is also noted that all or some of the information discussed herein can be based on data that is received, generated and/or maintained by one or more components of apparatus 200. In some embodiments, one or more external systems (such as a remote cloud computing and/or data storage system) may also be leveraged to provide at least some of the functionality discussed herein.

### Exemplary Administrator Computing Device

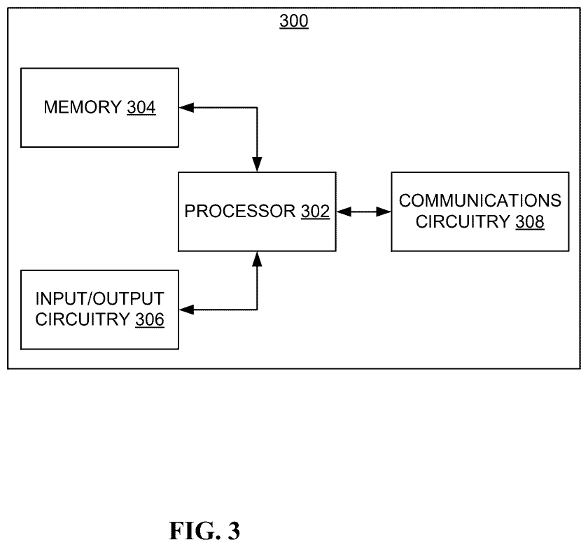

Referring now to FIG. 3, the administrator computing device 103 may be embodied by one or more computing systems, such as apparatus 300 shown in FIG. 3. The apparatus 300 may include processor 302, memory 304, input/output circuitry 306, and communications circuitry 308. Although these components 302-308 are described with respect to functional limitations, it should be understood that the particular implementations necessarily include the use of particular hardware. It should also be understood that certain of these components 302-308 may include similar or common hardware. For example, two sets of circuitries may both leverage use of the same processor, network interface, storage medium, or the like to perform their associated functions, such that duplicate hardware is not required for each set of circuitries.

In some embodiments, the processor 302 (and/or co-processor or any other processing circuitry assisting or otherwise associated with the processor) may be in communication with the memory 304 via a bus for passing information among components of the apparatus. The memory 304 is non-transitory and may include, for example, one or more volatile and/or non-volatile memories. In other words, for example, the memory 304 may be an electronic storage device (e.g., a computer-readable storage medium). The memory 304 may include one or more databases. Furthermore, the memory 304 may be configured to store information, data, content, applications, instructions, or the like for enabling the apparatus 300 to carry out various functions in accordance with example embodiments of the present disclosure. For example, the memory 304 may store obfuscated user alert data. As another example, the memory 304 may temporarily store communication data associated with one or more communication sessions. In another example, the memory 304 may store administrator profile data associated with the administrator computing device or user thereof, such as administrator credentials, keys, tokens, device identifiers, network identifiers, administrator privileges and/or the like.

The processor 302 may be embodied in a number of different ways and may, for example, include one or more processing devices configured to perform independently. In some preferred and non-limiting embodiments, the processor 302 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting embodiments, the processor 302 may be configured to execute instructions stored in the memory 304 or otherwise accessible to the processor 302. In some preferred and non-limiting embodiments, the processor 302 may be configured to execute hard-coded functionalities. As such, whether configured by hardware or software methods, or by a combination thereof, the processor 302 may represent an entity (e.g., physically embodied in circuitry) capable of performing operations according to an embodiment of the present disclosure while configured accordingly. Alternatively, as another example, when the processor 302 is embodied as an executor of software instructions (e.g., computer program instructions), the instructions may specifically configure the processor 302 to perform the algorithms and/or operations described herein when the instructions are executed. The apparatus 300 may execute or otherwise engage with the privacy obfuscation system 101 using the processor 302, input/output circuitry 306, and, in some embodiments, the communications circuitry 308. For example, the apparatus 300 may provide inputs to and receive output from the privacy obfuscation system 101.

In some embodiments, the apparatus 300 may include input/output circuitry 306 that may, in turn, be in communication with processor 302 to provide output to the user and, in some embodiments, to receive an indication of a user input. The input/output circuitry 306 may include a user interface and may include a display, and may include a web user interface, a mobile application, a query-initiating computing device, a kiosk, or the like. In some embodiments, the input/output circuitry 306 may also include a keyboard (e.g., also referred to herein as keypad), a mouse, a joystick, a touch screen, touch areas, soft keys, a microphone, a speaker, or other input/output mechanisms. The processor and/or user interface circuitry including the processor may be configured to control one or more functions of one or more user interface elements through computer program instructions (e.g., software and/or firmware) stored on a memory accessible to the processor (e.g., memory 304, and/or the like).

The communications circuitry 308 may be any means such as a device or circuitry embodied in either hardware or a combination of hardware and software that is configured to receive and/or transmit data from/to a network and/or any other device, circuitry, or module in communication with the apparatus 300. In this regard, the communications circuitry 308 may include, for example, a network interface for enabling communications with a wired or wireless communication network. For example, the communications circuitry 308 may include one or more network interface cards, antennae, buses, switches, routers, modems, and supporting hardware and/or software, or any other device suitable for enabling communications via a network. Additionally, or alternatively, the communications circuitry 308 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 300. In some embodiments, one or more external systems (such as a remote cloud computing and/or data storage system) may also be leveraged to provide at least some of the functionality discussed herein.

### Example Data Flows and Operations

To address some of the user privacy-related shortcomings of various existing approaches to providing security-related information to administrators, various embodiments of the present disclosure disclose techniques for obfuscating user data prior to provisioning such information to an administrator. For example, in some embodiments, a privacy obfuscation system obtains, from an alert service, an alert associated with at least one unique user identifier (UUID) based at least in part on a real-time monitoring of user activities on at least one application; renders a graphical user interface (GUI) comprising the alert on an administrator computing device via an application programming interface (API); receives, via the API, a request from the administrator computing device for user data associated with the alert; obtains, from a data store, user data and at least one user-configured privacy policy based on the at least one UUID; generates obfuscated user alert data at least in part by applying the at least one user-configured privacy policy to the user data; and causes provision of the obfuscated user alert data to the administrator computing device via the API for rendering on the GUI.

By utilizing the noted techniques for obfuscating user data, various embodiments of the present disclosure improve compliance with user-configured privacy policies and limit the exposure detailed user information. In doing so, the noted embodiments of the present disclosure can reduce the exposure of individualized user information and, instead, provide aggregated user information, which may better inform administrators of security trends by providing a holistic, more anonymized view of user activities. By improving privacy policy compliance and reducing exposure of individualized user information, the described embodiments of the present disclosure enhance information security. Accordingly, various embodiments of the present disclosure improve security of accessing information related to security alerts, events, and trends.

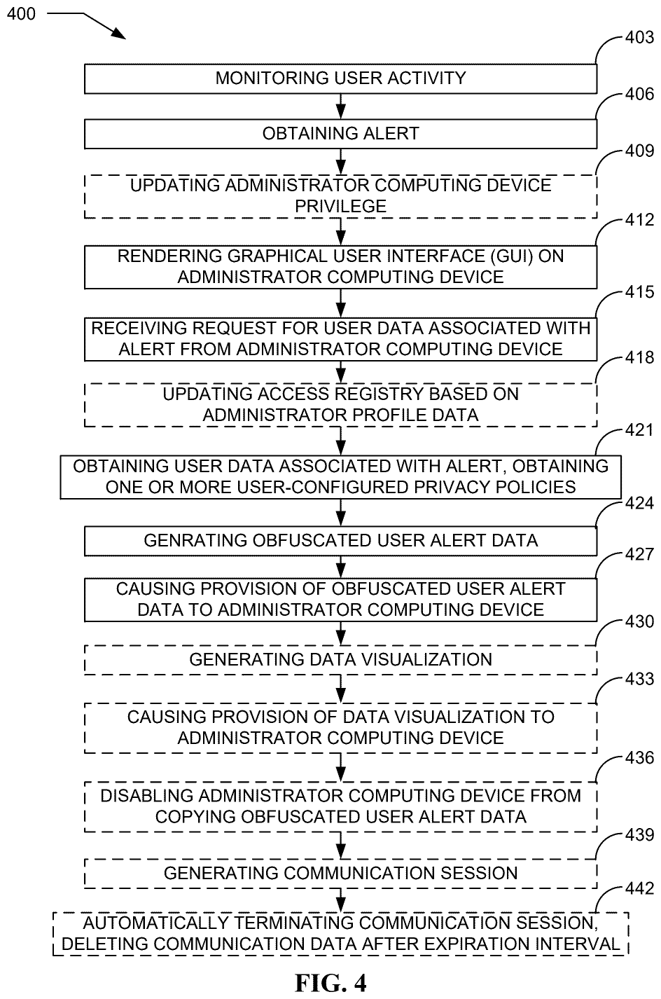

FIG. 4 is a flowchart diagram of an example obfuscation process for provisioning security-related information to an administrator computing device while complying with user-configured privacy policies in accordance with at least some embodiments of the present disclosure. The process 400 may be performed by various embodiments of the privacy obfuscation system 101 shown in FIG. 1 and described herein. For example, the process 400 may be performed by an apparatus 200 that embodies functionality of the privacy obfuscation system 101 described herein. In some embodiments, via various operations of the process 400, the privacy obfuscation system 101 may improve compliance with user-configured privacy policies and reduce exposures of individualized user data by obfuscating user data prior to its provision to an administrator computing device.

At operation 403, the process 400 includes monitoring user activities on one or more applications. For example, the apparatus performing the process 400 includes means, such as the processor 202, the memory 204, the input/output circuitry 206, the communication circuitry 208, the data processing circuitry 209, the data obfuscation circuitry 211, or the like, for monitoring user activities on at least one application 104. In some embodiments, the alert service 105 receives and analyses, in substantially real-time, user activity-related data for one or more users and for one or more applications 104. In some embodiments, the alert service 105 determines whether user activity matches one or more predetermined patterns, satisfies one or more predetermined thresholds, or otherwise demonstrates association with anomalous behavior or another predefined behavior. In some embodiments, the alert service 105 embodies a computing environment that is external to and in communication with the apparatus performing the process 400.

At operation 406, the process 400 includes obtaining an alert based on the monitoring of user activities. For example, the apparatus performing the process 400 includes means, such as the processor 202, the memory 204, the input/output circuitry 206, the communication circuitry 208, the data processing circuitry 209, the data obfuscation circuitry 211, or the like, for obtaining an alert 106. In some embodiments, the apparatus performing the process 400 obtains the alert 106 from an external computing environment that embodies an alert service 105 as described herein. In some embodiments, the apparatus performing the process 400 generates the alert 106. For example, the apparatus includes or embodies an alert service 105 that generates the alert 106 based on the real-time monitoring of user activities on one or more applications. In some embodiments, the alert includes or is associated with one or more unique user identifiers (UUIDs) 123.

At operation 409, the process 400 optionally includes updating one or more privileges of one or more administrator computing devices 103 based on the alert. For example, the apparatus performing the process 400 optionally includes means, such as the processor 202, the memory 204, the input/output circuitry 206, the communication circuitry 208, the data processing circuitry 209, the data obfuscation circuitry 211, or the like for updating one or more privileges of one or more administrator computing devices 103 based on the alert 106. For example, the apparatus may include or embody a request service 107 configured to update an administrator privilege of an administrator computing device 103 based on the UUID 123 or alert 106 to enable the administrator computing device 103 to initiate an alert-based query of user data 125 respective to the UUID 123 and/or alert 106.

At operation 412, the process 400 includes rendering a graphical user interface (GUI) on a display of the administrator computing device. For example, the apparatus performing the process 400 includes means, such as the processor 202, the memory 204, the input/output circuitry 206, the communication circuitry 208, the data processing circuitry 209, the data obfuscation circuitry 211, or the like, for rendering a GUI on a display of the administrator computing device 103. In some embodiments, the apparatus provisions the GUI (or a command to render the GUI) to the administrator computing device 103 via an application programming interface (API). In some embodiments, the GUI includes the alert 106, the UUID 123, and/or the like. For example, the GUI may include the UUID 123 and an indication of one or more thresholds, anomalous behaviors, patterns, and/or the like, based upon which the alert was generated. In some embodiments, the GUI includes the alert 106 but excludes UUIDs 123 associated with the alert 106 such that the UUIDs 123 are not exposed to the administrator. In some embodiments, the GUI embodies an obfuscated user alert data interface including the alert, obfuscated user alert data associated with the alert, one or more UUIDs, and/or the like. For example, the GUI may embody any of the obfuscated user alert data interfaces 500, 600A, 600B, 700A, 700B, or 800 shown in FIGS. 5, 6A, 6B, 7A, 7B, and 8, respectively, and described herein.

At operation 415, the process 400 includes receiving a request for user data associated with the alert from the administrator computing device. For example, the apparatus performing the process 400 includes means, such as the processor 202, the memory 204, the input/output circuitry 206, the communication circuitry 208, the data processing circuitry 209, the data obfuscation circuitry 211, or the like, for receiving a request for user data 125 from the administrator computing device 103. In some embodiments, the apparatus receives the request via an API. In some embodiments, the request includes one or more UUIDs 123 associated with the alert. In some embodiments, the alert includes an identifier that excludes any UUIDs 123 and which may be mapped by the apparatus to one or more stored UUIDs 123 associated with the alert (e.g., thereby avoiding disclosure of the UUID 123 to the administrator computing device at operation 412). In some embodiments, the alert includes or indicates one or more requested types of user data 125 (e.g., particular application actions, association with particular applications, and/or the like) or a particular time interval (e.g., previous day, previous week, previous year, or any suitable time interval). In some embodiments, the request includes administrator profile data 133 associated with the administrator computing device 103. For example, the request includes an administrator identifier, device identifier, and/or the like.

At operation 418, the process 400 includes optionally includes updating an access registry based on administrator profile data from the request. For example, the apparatus performing the process 400 optionally includes means, such as the processor 202, the memory 204, the input/output circuitry 206, the communication circuitry 208, the data processing circuitry 209, the data obfuscation circuitry 211, or the like, for updating an access registry 115 based on administrator profile data 133 provided within the request. In some embodiments, the apparatus generates a new entry to the access registry including data associated with the request. For example, the entry includes the alert 106, one or more UUIDs 123, administrator profile data 133, and/or the like.

At operation 421, the process 400 includes obtaining user data associated with the alert and obtaining one or more user-configured privacy policies (e.g., based on the UUID associated with the alert). For example, the apparatus performing the process 400 includes means, such as the processor 202, the memory 204, the input/output circuitry 206, the communication circuitry 208, the data processing circuitry 209, the data obfuscation circuitry 211, or the like, for obtaining user data 125 and one or more user-configured privacy policies 127 from a data store 111 based on the one or more UUIDs 123. In some embodiments, an obfuscation service 109 retrieves the user data 125 based on additional data from the request, such as one or more requested data types, time intervals, and/or the like. In some embodiments, the obfuscation service 109 initiates one or more alert-based queries of user data 125 at one or more data stores 102, where the alert-based query returns, as output, alert-related data, non-alert-related data, and/or the like, as defined herein.

At operation 424, the process 400 includes generating obfuscated user alert data based on the user data associated with the alert. For example, the apparatus performing the process 400 includes means, such as the processor 202, the memory 204, the input/output circuitry 206, the communication circuitry 208, the data processing circuitry 209, the data obfuscation circuitry 211, or the like, for generating obfuscated user alert data 129 based on applying the one or more user-configured privacy policies 127, data aggregation or abstraction policies, and/or the like, to the user data 125. As one example, the user data 125 includes a plurality of filenames accessed by at a user associated with the UUID. The apparatus performing the process 400 may generate a file count based on the plurality of filenames. The obfuscated user alert data 129 may include the file count and exclude the plurality of filenames. As another example, the apparatus may generate an access frequency count based on the plurality of filenames and corresponding access timestamps. The obfuscated user alert data 129 may be a file count generated based on a subset of the plurality of filenames for which the access frequency count meets a predetermined threshold 117. In some embodiments, the apparatus filters one or more fields from the user data 125 based on the user-configured privacy policy 127. For example, based on application of the user-configured privacy policy to the user data 125, the obfuscated user alert data 129 may omit a legal name field and a location field and retain a nickname field. As another example, the apparatus may generate generalized or abstracted iterations of user data 125, such as generalized location data that avoids precisely identifying the location of the user associated with the UUID 123 (e.g., or computing device of the user).

At operation 427, the process 400 includes causing provision of the obfuscated user alert data to the administrator computing device for rendering on the GUI. For example, the apparatus performing the process 400 includes means, such as the processor 202, the memory 204, the input/output circuitry 206, the communication circuitry 208, the data processing circuitry 209, the data obfuscation circuitry 211, or the like, for causing provision of the obfuscated user alert data 129 to the administrator computing device 103 for rendering. In some embodiments, the apparatus provisions the obfuscated user alert data 129 to the administrator computing device 103 via the API. In some embodiments, the administrator computing device 103 updates the GUI to include the obfuscated user alert data 129.

In some embodiments, at operation 427, the apparatus performing the process 400 includes means, such as the processor 202, the memory 204, the input/output circuitry 206, the communication circuitry 208, the data processing circuitry 209, the data obfuscation circuitry 211, or the like, for generating an obfuscated user alert data interface and causing rendering of the obfuscated user alert data interface on the administrator computing device 105. For example, the apparatus may generate an obfuscated user alert data interface 500 and render the interface on the administrator computing device 103 (as shown in FIG. 5 and described herein). In some embodiments, the obfuscated user alert data interface includes one or more selectable fields for requesting deobfuscation of one or more portions of the obfuscated user alert data. The obfuscated user alert data interface may receive a selection to the selectable field via one or more input devices. In response to the selection, the administrator computing device 103 may generate and provision a request for deobfuscation of one or more portions of the obfuscated user alert data to the apparatus performing the process 400.

In some embodiments, subsequent to provisioning the obfuscated user alert data 129 to the administrator computing device 105, the apparatus receives a request for deobfuscation of the user data 125 which was filtered out of, anonymized, or abstracted in the obfuscated user alert data. In some embodiments, the apparatus includes means, such as the processor 202, the memory 204, the input/output circuitry 206, the communication circuitry 208, the data processing circuitry 209, the data obfuscation circuitry 211, or the like, for determining whether to perform the requested deobfuscation based on one or more user-configured privacy policies 127, one or more organization policies, administrator privileges 121, and/or the like. In response to determining the deobfuscation is permissible, the apparatus performing the process 400 may cause provision of one or more portions of the user data 125 based on which the obfuscated user alert data 129 was generated at operation 424.

At operation 430, the process 400 optionally includes generating one or more data visualizations based on the obfuscated user alert data. For example, the apparatus performing the process 400 includes means, such as the processor 202, the memory 204, the input/output circuitry 206, the communication circuitry 208, the data processing circuitry 209, the data obfuscation circuitry 211, or the like, for generating a data visualization based on the obfuscated user alert data 129. In some embodiments, the data visualization includes a time series chart of user activities, such as page access events, logins, signups, and/or the like. In some embodiments, the data visualization includes a frequency-based chart, such as a histogram, line graph, bar graph, and/or the like. For example, the data visualization may be a histogram that indicates a frequency of page access events by one or more users, where the users may be denoted by their respective UUIDs 123. A data visualization may embody the data visualization 501 or data visualization 502 as shown in FIG. 5 and described herein.

At operation 433, the process 400 optionally includes causing provision of the data visualization to the administrator computing device for rendering on the GUI. For example, the apparatus performing the process 400 includes means, such as the processor 202, the memory 204, the input/output circuitry 206, the communication circuitry 208, the data processing circuitry 209, the data obfuscation circuitry 211, or the like, for causing provision of the data visualization to the administrator computing device 103 for rendering on the GUI. In some embodiments, the apparatus provisions the data visualization to the administrator computing device 103 via the API.

At operation 436, the process 400 optionally includes disabling the administrator computing device from copying the obfuscated user alert data provisioned to the administrator computing device. For example, the apparatus performing the process 400 includes means, such as the processor 202, the memory 204, the input/output circuitry 206, the communication circuitry 208, the data processing circuitry 209, the data obfuscation circuitry 211, or the like, for disabling the administrator computing device 103 from executing one or more operations to copy, duplicate, or extract the obfuscated user alert data 129 that was provisioned to and rendered on the administrator computing device 103.

At operation 439, the process 400 optionally includes generating a communication session between the administrator computing device and one or more additional administrator computing devices for purposes of reviewing and/or discussing the event, the obfuscated user alert data, and/or the like. For example, the apparatus performing the process 400 includes means, such as the processor 202, the memory 204, the input/output circuitry 206, the communication circuitry 208, the data processing circuitry 209, the data obfuscation circuitry 211, or the like, for generating a communication session between the administrator computing device 103 to which obfuscated user alert data 129 was provisioned and one or more additional computing devices. In some embodiments, the apparatus provisions a request to generate or participate in the communication session to the additional computing device. The apparatus may generate the communication session in response to receiving an approval of the request from the additional computing device, or block generation of the communication session in response to request disapproval.

At operation 442, the process 400 optionally includes automatically terminating the communication session and deleting associated communication data upon elapse of a predetermined expiration interval. For example, the apparatus performing the process 400 includes means, such as the processor 202, the memory 204, the input/output circuitry 206, the communication circuitry 208, the data processing circuitry 209, the data obfuscation circuitry 211, or the like, for determining completion of a predetermined expiration interval and, in response, i) terminating the communication session between the administrator computing devices 103, and ii) deleting communication data 119 associated with the communication session. In some embodiments, the predetermined expiration interval is a threshold 117 stored at the data store 111. The predetermined expiration interval may embody any suitable value, such as 1 day, 1 month, 6 months, and/or the like. In some embodiments, periodic deletion of communication sessions may reduce a likelihood of exposing user data by avoiding permanent storage of discussions of user activities.

FIG. 5 shows an administrator computing device 103 including a rendering of an example obfuscated user alert data interface 500. In some embodiments, the obfuscated user alert data interface 500 includes data visualizations 501, 502 based obfuscated user alert data. In various embodiments, the data visualization 501 indicates a quantity of unique page views per hour 503 as a function of time 505, and the data visualization 502 indicates a quantity of non-unique page views per hour 507 as a function of time 509.

In some embodiments, the obfuscated user alert data interface 500 includes one or more selectable fields 511 that enable an administrator computing device 103 to request deobfuscation of one or more portions of obfuscated user alert data. For example, in response to the obfuscated user alert data interface 500 receiving a selection to the selectable field 511, the administrator computing device 103 may generate a request to perform deobfuscation of one or more portions of obfuscated user alert data shown on the obfuscated user alert data interface 500. The administrator computing device 103 may provision the request to the privacy obfuscation system 101, which may approve or deny the request. In some embodiments, in response to the request, the privacy obfuscation system 101 performs a deobfuscation operation to recover, regenerate, or otherwise obtain user data associated with the one or more portions of the obfuscated user alert data. For example, where the obfuscated user alert data includes a file count, the privacy obfuscation system 101 may generate (and update the obfuscated user alert data interface 500 to include) a listing of respective filenames that are associated with the files represented in the file count. As another example, the privacy obfuscation system 101 may update the obfuscated user alert data interface 500 to include one or more fields of user data that were previously excluded from presentation to the administrator computing device 103. In some embodiments, upon selection of the selectable field 511, the obfuscated user alert data interface 500 enables the administrator computing device 103 to indicate one or more data types and/or select one or more portions of displayed information for which deobfuscation is requested.

In some embodiments, the privacy obfuscation system 101 generates the data visualizations 501, 502 based on obfuscated user alert data, where the obfuscated user alert data is generated based on an abstraction of original user data associated with an alert. For example, the original user data may include a list of the specific page titles accessed by a user and timestamps corresponding to the instance of access. Instead of providing the listing of specific page titles and timestamps to an administrator computing device, the privacy obfuscation system 101 may generate obfuscated user alert data by determining a count of unique page views per hour and non-unique page views per hour based on the listing of specific page titles and timestamps. By provisioning the counts to the administrator computing device, the privacy obfuscation system 101 may provide useful security trend information while avoiding the disclosure of individualized user information. The privacy obfuscation system 101 may further generate the data visualizations 500A, 500B based on respective time series of counts of unique page views per hour and non-unique page views per hour, thereby further abstracting from individualized user information while providing a holistic presentation of security trends.

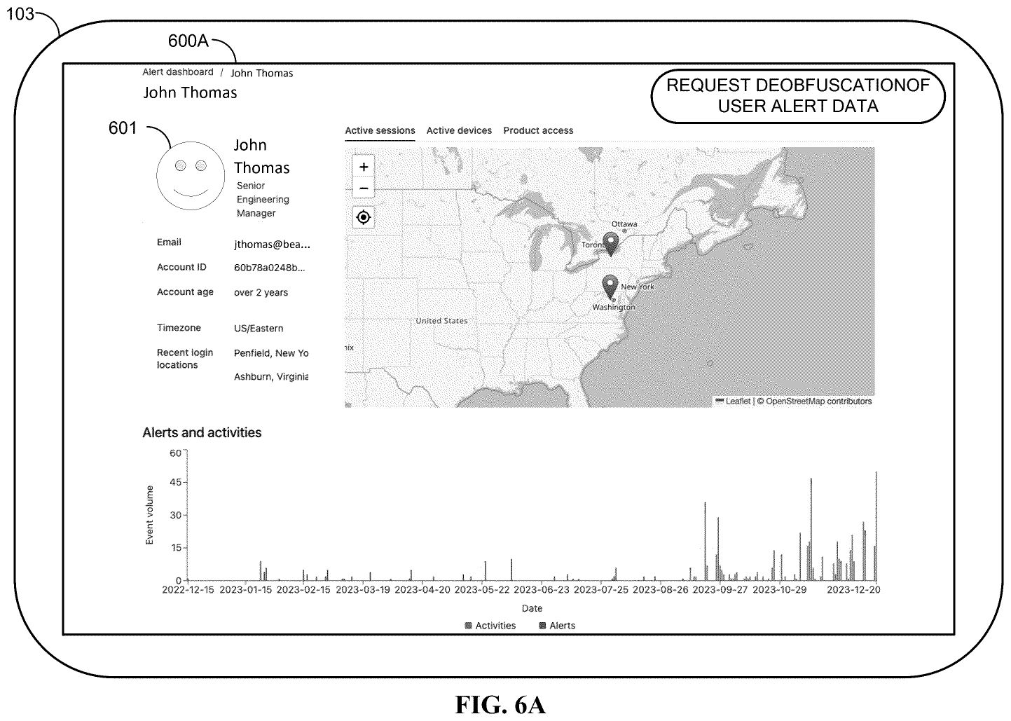

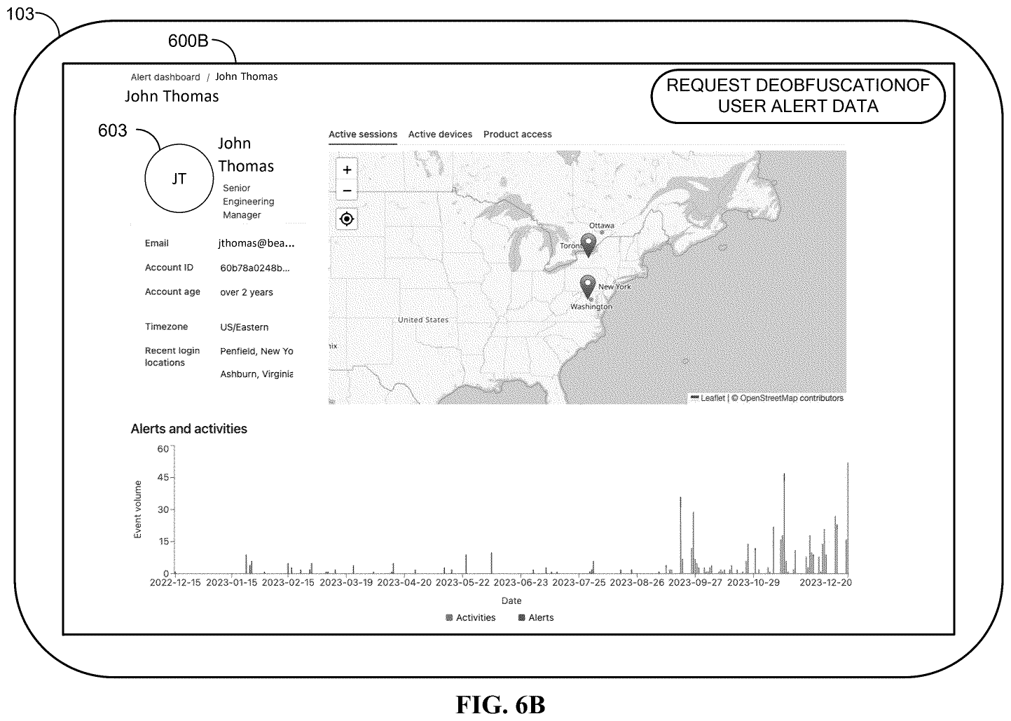

FIG. 6A shows an administrator computing device 103 including a rendering of an example obfuscated user alert data interface 600A. In various embodiments, the obfuscated user alert data interface 600A includes user data and obfuscated user alert data provisioned by the privacy obfuscation system 101. The obfuscated user alert data and user data may be generated and/or provisioned by the privacy obfuscation system 101 based on one or more user-configured privacy policies. For example, a user profile may include a first user-configured privacy policy that causes the privacy obfuscation system 101 to prevent rendering or other provision of precise location data (e.g., IP address, physical address, and/or the like) to the administrator computing device 103. The first user-configured privacy policy may cause the privacy obfuscation system 101 to generate and render on the obfuscated user alert data interface 600A generalized location data including a city and state of the user. The user profile may include a second user-configured privacy policy that permits rendering of the user's profile image 601 on the obfuscated user alert data interface 600A.

FIG. 6B shows an administrator computing device 103 including a rendering of an example obfuscated user alert data interface 600B. As shown in the obfuscated user alert data interface 600B, the second user-configured privacy policy (discussed herein in the context of FIG. 6A) may be adjusted to prevent provision of the user's profile image 601 to the administrator computing device 103. For example, the second user-configured privacy policy may cause the privacy obfuscation system 101 to substitute, in the obfuscated user alert data interface, a user's profile image 601 (FIG. 6A) for a generic profile image 603.

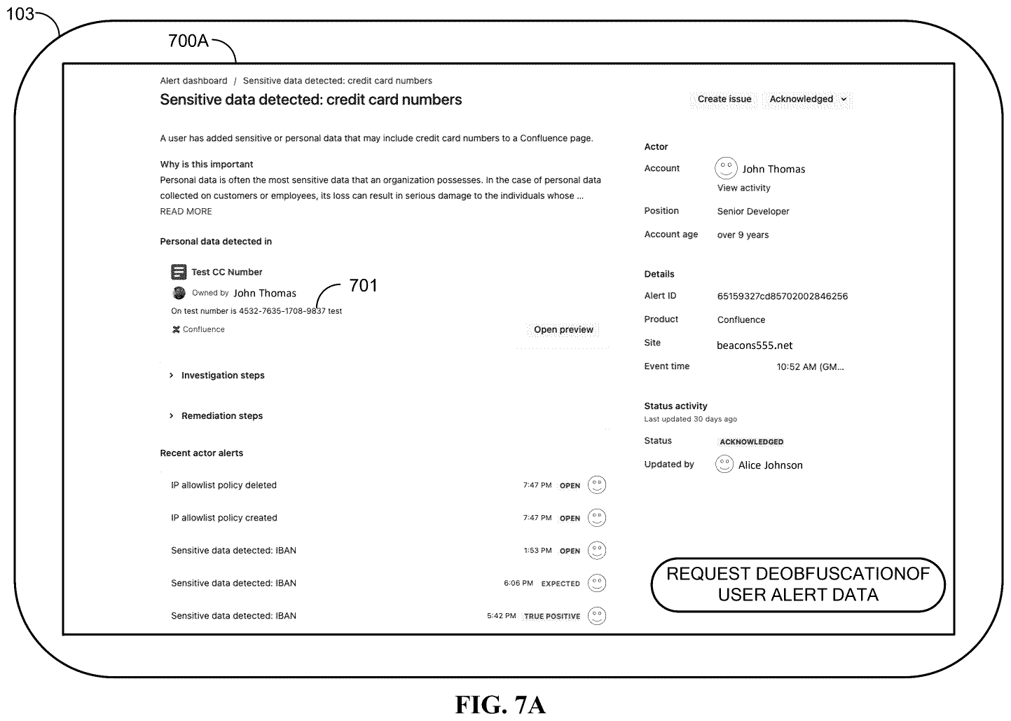

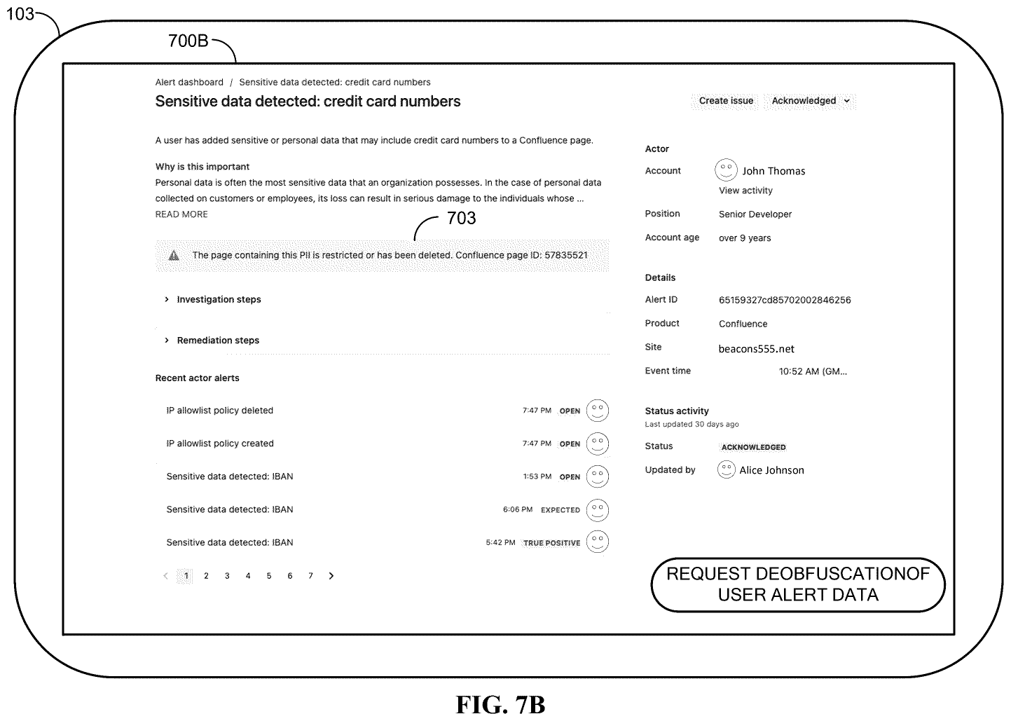

FIG. 7A shows an administrator computing device 103 including a rendering of an example obfuscated user alert data interface 700A. FIG. 7B shows an administrator computing device 103 including a rendering of an example obfuscated user alert data interface 700B. The obfuscated user alert data interfaces 700A, 700B shown in FIGS. 7A, 7B, respectively, demonstrate selective obfuscation of sensitive payment processing information based on user-configured privacy policies. For example, in the context of the obfuscated user alert data interface 700A, a user profile may include a user-configured privacy policy that enables provision of the user's payment data 701 to an administrator computing device. In the context of the obfuscated user alert data interface 700B, the user-configured privacy policy may be updated in response to input from a user's computing device. The updated user-configured privacy policy may cause the privacy obfuscation system 101 to obfuscate the user's payment data such that the payment data is not disclosed to the administrator computing device 103. For example, instead of rendering the payment data 701 on the obfuscated user alert data interface 700B, the administrator computing device 103 may render a notice 703 that indicates the user's payment data is restricted from being viewed or accessed by the administrator.

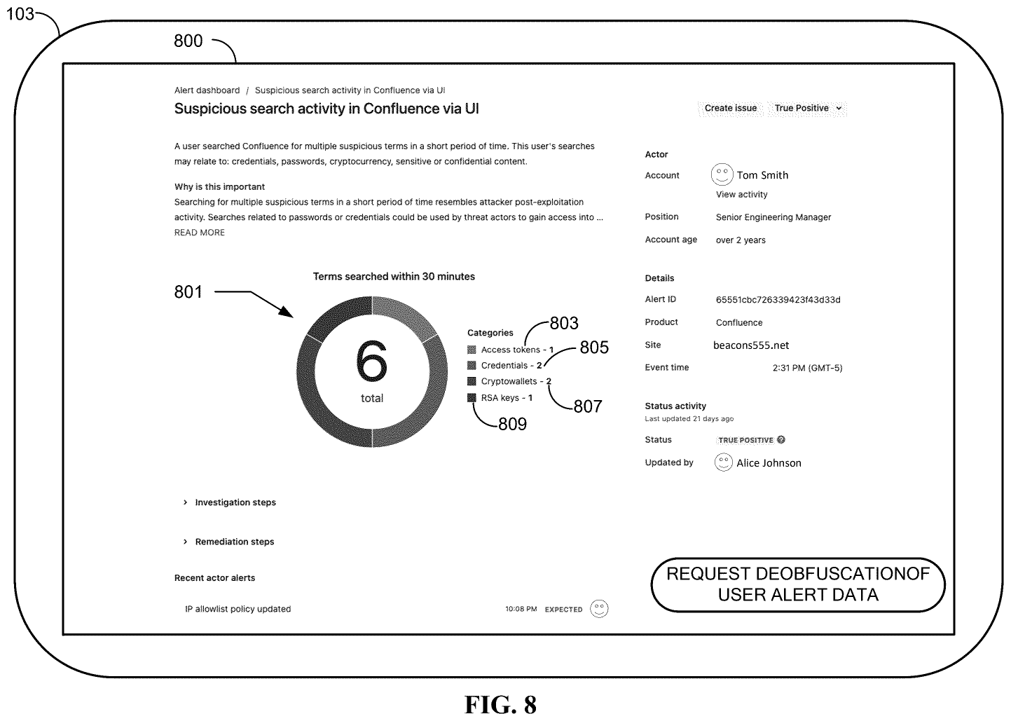

FIG. 8 shows an administrator computing device 103 including a rendering of an example obfuscated user alert data interface 800. In various embodiments, the obfuscated user alert data interface 800 includes a data visualization 801 that may be generated by the privacy obfuscation system 101 based on obfuscated user alert data, user data, user-configured privacy policies, and/or the like. For example, alert-related user data may include a set of keywords searched by a user. A user profile associated with the user may include a user-configured privacy policy for preventing viewing or access of search engine inputs by administrators. Alternatively, or additionally, the user profile may be associated with an organizational policy that prohibits unauthorized access or viewing of user search engine inputs by administrators. Based on the user-configured privacy policy may cause the privacy obfuscation system 101 may perform an obfuscation operation including generating (or retrieving) a respective association between each keyword and a predefined data category. For example, the privacy obfuscation system 101 may associate the set of keywords, or subsets thereof, with an access token category 803, a credentials category 805, a cryptocurrency category 807, and a cryptographic key category 809. The privacy obfuscation system 101 may generate a data visualization 801 based on the set of keywords and category associations, where the data visualization 801 indicates the categories of keywords associated with the alert but excludes the keywords. The privacy obfuscation system 101 may cause rendering of the data visualization 801 on the obfuscated user alert data interface 800 to enable an administrator to observe alert-related information (e.g., search category trends) without being provisioned the user's specific keyword searches. In doing so, the privacy obfuscation system 101 may overcome technical challenges associated with providing useful alert-related intelligence to an administrator while simultaneously complying with user-configured privacy settings.

### Additional Implementation Details

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer-readable storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially-generated propagated signal. The computer-readable storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (Application Specific Integrated Circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's query-initiating computing device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a query-initiating computing device having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., a Hypertext Markup Language (HTML) page) to a query-initiating computing device (e.g., for purposes of displaying information/data to and receiving user input from a user interacting with the query-initiating computing device). Information/data generated at the query-initiating computing device (e.g., a result of the user interaction) can be received from the query-initiating computing device at the server.

While this specification contains many specific implementation details, these should not be construed as limitations on the scope of any inventions or of what may be claimed, but rather as description of features specific to particular embodiments of particular inventions. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

### CONCLUSION

Many modifications and other embodiments of the inventions set forth herein will come to mind to one skilled in the art to which these inventions pertain having the benefit of the teachings presented in the foregoing description and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. A computer-implemented method for alert identification with privacy obfuscation, comprising:
obtaining an alert associated with at least one unique user identifier (UUID) based at least in part on a real-time monitoring of user activities on at least one application;
rendering the alert on a display of an administrator computing device via an application programming interface (API);
receiving, via the API, a request for user data associated with the alert;
obtaining the user data associated with the alert by initiating at least one query of stored user data, wherein the at least one query is performed based on at least one of the alert or the at least one UUID;
obtaining at least one user-configured privacy policy based on the at least one UUID;
generating obfuscated user alert data at least in part by applying at least one user-configured privacy policy to the user data associated with the alert; and
causing provision of the obfuscated user alert data to the administrator computing device via the API for rendering on the display.

2. The method of claim 1, wherein:
the provision of the obfuscated user alert data to the administrator computing device causes the administrator computing device to render an obfuscated user alert interface on the display of the administrator computing device; and
the obfuscated alert interface comprises at least one data visualization based on the obfuscated user alert data.

3. The method of claim 1, wherein:
the user data associated with the alert comprises a plurality of filenames accessed by at least one user associated with the at least one UUID; and
generating the obfuscated user alert data comprises generating a file count based on the plurality of filenames, wherein the obfuscated user alert data comprises the file count and excludes the plurality of filenames.

4. The method of claim 3, wherein:
the user data associated with the alert comprises respective access timestamps for the plurality of filenames, wherein each timestamp indicates a date of access by the at least one user associated with the at least one UUID; and
the method further comprises:
generating an access frequency count for each of the plurality of filenames based on the respective access timestamps; and
generating the file count based on a subset of the plurality of filenames for which the respective access frequency count satisfies a predetermined threshold.

5. The method of claim 4, further comprising:
generating a data visualization based on the subset of the plurality of filenames and the respective access frequency counts; and
causing provision of the data visualization to the administrator computing device via the API for rendering on the GUI.

6. The method of claim 1, further comprising:
generating a user count based on the at least one UUID, wherein the obfuscated user alert data comprises the user count and excludes the at least one UUID.

7. The method of claim 1, further comprising:
disabling the administrator computing device from executing one or more operations to copy the obfuscated user alert data from the GUI.

8. The method of claim 1, further comprising:
in response to the alert, generating a communication session between the administrator computing device and at least one additional computing device, wherein the communication session is associated with a predetermined expiration interval.

9. The method of claim 8, further comprising:
in response to determining completion of the predetermined expiration interval:
automatically terminating the communication session; and
deleting communication data associated with the communication session.

10. The method of claim 8, further comprising:
causing provision of a request to generate the communication session to a second administrator device, the request to generate the communication session comprising at least one of the alert or the obfuscated user alert data; and
generating the communication session in response to receiving an approval of the request from the at least one additional computing device.

11. An apparatus for alert identification with privacy obfuscation, the apparatus comprising at least one processor and at least one non-transitory memory comprising program code, wherein the at least one non-transitory memory and the program code are configured to, with the at least one processor, cause the apparatus to:
obtain an alert associated with at least one unique user identifier (UUID) based at least in part on a real-time monitoring of user activities on at least one application;
render a graphical user interface (GUI) comprising the alert on an administrator computing device via an application programming interface (API);
receive, via the API, a request from the administrator computing device for user data associated with the alert;
perform at least one alert-based query to obtain the user data associated with the alert;
obtain at least one user-configured privacy policy based on the at least one UUID;
generate obfuscated user alert data at least in part by applying the at least one user-configured privacy policy to the user data associated with the alert; and
render an obfuscated user alert data interface on the administrator computing device, the obfuscated user alert data interface comprising the obfuscated user alert data.

12. The apparatus of claim 10, wherein:
the user data associated with the alert comprises a plurality of fields; and
the obfuscated user alert data comprises a permitted subset of the plurality of fields based on the at least one user-configured privacy policy.

13. The apparatus of claim 12, wherein:
the plurality of fields comprises at least one of a username, legal name, user image, email address, location, timezone, organization, department, team type, demographic data, political data, religion data, union membership data, biometric data, or health data.

14. The apparatus of claim 10, wherein:
the obfuscated user alert data interface comprises at least one selectable field for requesting deobfuscation of at least a portion of the obfuscated user alert data.

15. The apparatus of claim 14, wherein the at least one non-transitory memory and the program code are further configured to, with the at least one processor, cause the apparatus to:
in response to the administrator computing device receiving an input to at least one selectable field of the obfuscated alert data interface, receive, via the API, a second request from the administrator computing device for deobfuscation of the at least one portion of the obfuscated user alert data; and
generate a response to the second request based on at least one of i) at least one organization policy associated with the at least one UUID, or ii) at least one administrator privilege associated with the administrator computing device, wherein the response comprises a portion of the user data associated with the at least one portion of the obfuscated user alert data.

16. The apparatus of claim 15, wherein:
the response to the second request comprises an approval for the deobfuscation of the at least one portion of the obfuscated user alert data; and
the at least one non-transitory memory and the program code are further configured to, with the at least one processor, cause the apparatus to:
recover at least one portion of the user alert data by performing at least one operation to deobfuscate the at least one portion of the obfuscated user alert data; and
render the at least one portion of the user alert data on the obfuscated alert data interface.

17. The apparatus of claim 10, wherein:
the request for the user data associated with the alert comprises administrator profile data associated with the administrator computing device;
the at least one non-transitory memory and the program code are further configured to, with the at least one processor, cause the apparatus to:
update an access registry based on the administrator profile data in response to the provision of the obfuscated user alert data to the administrator computing device.

18. The apparatus of claim 10, wherein the at least one non-transitory memory and the program code are further configured to, with the at least one processor, cause the apparatus to:
in response to the alert, update at least one privilege associated with the administrator computing device to enable the administrator computing device to request user data respective to the at least one UUID.

19. The apparatus of claim 10, wherein:
the user data associated with the alert comprises an internet protocol (IP) address; and
wherein the at least one non-transitory memory and the program code are further configured to, with the at least one processor, cause the apparatus to:
generate generalized location data based on the IP address, wherein:
the obfuscated user alert data comprises the generalized location data and excludes the IP address; and
the generalized location data comprises at least one of: a hemisphere identifier, a country identifier, or a regional identifier.

20. A computer program product for alert identification with privacy obfuscation, the computer program product comprising at least one non-transitory computer-readable storage medium having computer-readable program code portions stored therein, the computer-readable program code portions configured to:
obtain an alert associated with at least one unique user identifier (UUID) based at least in part on a real-time monitoring of user activities on at least one application;
perform at least one query of user data at a data store based on the alert to obtain a subset of the user data that is associated with the alert;
obtain at least one user-configured privacy policy based on the at least one UUID;
generate obfuscated user alert data at least in part by applying at least one user-configured privacy policy to the subset of the user data that is associated with the alert; and
render, on a display of at least one administrator computing device, an obfuscated alert data interface comprising the obfuscated user alert data.
